(19) United States
(12) Patent Application Publication
(10) Pub. No.: US 2011/0252655 A1
(43) Pub. Date: Oct. 20, 2011

(54) APPARATUS AND METHODS FOR SURVEYING WITH A HYDRANT MONUMENT

(76) Inventor: Darrell G. B. Cline, Oro Station (CA)

(21) Appl. No.: 13/052,228

(22) Filed: Mar. 21, 2011

(51) Int. Cl. G01C 5/00; F16B 1/00

(52) U.S. Cl. 33/228; 248/205.1; 33/299

(57) ABSTRACT

An apparatus is disclosed to secure survey equipment to a top portion of a hydrant monument. The apparatus comprises a support plate having an upper surface and a lower surface. The support plate is adapted to be securely mounted to the top cover of the hydrant monument. The apparatus also comprises an attachment device to secure the survey equipment proximate the upper surface of the support plate.

### FIELD OF THE INVENTION

The present invention relates generally to surveying, and more particularly to surveying using fire hydrants, or other fixed monuments, as survey monuments.

### BACKGROUND OF THE INVENTION

There are several different types of surveys. For example, geodetic surveys cover a large geographic area and attempt to define the exact three-dimensional coordinates (northing, easting and elevation) of geodetic reference points on the earth's surface. Cadastral surveys are typically boundary surveys to define legal or political boundaries on plans. Topographical and construction surveys are often tied to independently-adjusted networks of control points, and often to survey monuments used for either cadastral surveys or geodetic networks set by a government body.

An advantageous method of surveying involves using fire hydrants as survey monuments as is described in U.S. Pat. No. 6,874,238, the contents of which are hereby incorporated herein by reference. A system employing fire hydrants as survey monuments may be easily maintained and may be maintained in conjunction with a municipal or private water system. Additionally, employing fire hydrants as survey monuments permits ready identification of a monument in a variety of climate conditions compared to monuments mounted into, and flush, with the ground. For example, fire hydrants can be more readily identified in adverse climate conditions, such as, when snow is present on the ground. Furthermore, the distance between fire hydrants may not typically be very large, especially in urban areas, providing numerous reference points to ensure survey accuracy. Hydrant monuments can also supplement other conventional types of survey monuments.

A fire hydrant survey monument can be used during a surveying operation by having a surveyor set up a support tripod above a reference point located on the hydrant monument. In this respect, surveying from a hydrant monument is not much different than surveying from any other type of survey monument. A particular location on the hydrant monument, such as the operating nut of the hydrant, can be the reference point. A survey instrument, such as a total station may be mounted on the tripod permitting the surveyor to take measurements once the tripod has been positioned appropriately in relation to the reference point on the hydrant monument.

Current methods of surveying employing survey monuments suffer from some drawbacks. For example, it is time consuming to accurately place a tripod over a reference point on a survey monument. Accurately positioning a tripod over a reference point on a hydrant monument may be further complicated by the local environment. For example, an uneven frozen surface such as a snow bank or drift located in the vicinity of the hydrant may complicate the tripod setup. Also, the base of the tripod may not be otherwise stabilized on the ground. Additionally, the height of the tripod above the reference point must be manually determined in certain types of surveys, such as a 3D topographical survey, permitting the introduction of error resulting from inaccuracies in the height determination.

It is known to affix simple types of survey targets directly to the operating nut of a fire hydrant. However, known attachment devices do not permit highly accurate leveling and alignment and consequently may not be suitable for surveys requiring a high degree of precision. For example, known attachment devices do not permit survey targets to be attached using a fine leveling adapter, which may be required for certain types of high accuracy surveys. Similarly, existing attachment methods do not provide a secure and stable mount suitable to directly attach a survey instrument, such as a total station, to a hydrant monument for use in conducting a survey.

### SUMMARY OF THE INVENTION

It has been recognized that a hydrant monument can be utilized and/or adapted to mount sophisticated and sensitive survey equipment for use in survey operations.

An apparatus is disclosed that may permit survey equipment, such as a survey instrument, to be attached to a hydrant monument without the use of a tripod. The apparatus may facilitate efficient and accurate surveying with the instrument from the hydrant monument. It may be easier and more efficient to connect a survey instrument, to the hydrant itself, rather than configuring a tripod over the survey monument. Directly configuring a survey instrument, such as a total station, to a hydrant may not only improve the efficiency of the resulting survey but may also increase the resulting accuracy by reducing sources of error.

According to one aspect of the invention there is provided an apparatus to secure survey equipment to a top portion of a hydrant monument, the apparatus comprising: (a) a support plate having an upper surface and a lower surface, the support plate adapted to be securely mounted to the top cover of the hydrant monument; and (b) an attachment device to secure the survey equipment proximate the upper surface of the support plate.

According to another aspect of the invention there is provided an apparatus comprising: (a) a hydrant monument; (b) a survey instrument; (c) a support plate having an upper surface and a lower surface, the support plate adapted to be securely mounted to the hydrant monument; and (d) an attachment device to secure the survey instrument at the upper surface of the support plate.

According to a further aspect of the invention there is provided an apparatus to secure survey equipment to a hydrant monument comprising: (a) an upper plate adapted to secure survey equipment to an upper surface; (b) a lower plate; the upper plate connected to the lower plate so that the upper plate can be leveled relative to the lower plate; and the lower plate having an aperture to receive a securing device to secure the lower plate to the hydrant monument.

According to a still further aspect of the invention there is provided an apparatus to secure survey equipment to a hydrant monument comprising: (a) an upper plate adapted to secure survey equipment to an upper surface; (b) a lower plate; the upper plate connected to the lower plate so that the upper plate can be leveled relative to the lower plate; and the lower plate having mounting projections extending from a lower surface of the lower plate to be at least partially received by aligned mounting apertures on the top cover to securely mount the lower plate to a top cover of the hydrant monument.

According to another aspect of the invention there is provided an apparatus comprising: (a) a hydrant monument having a top cover; (b) a survey instrument; (c) an upper plate adapted to secure the survey instrument to an upper surface; (d) a lower plate; the upper plate connected to the lower plate so that the upper plate can be leveled relative to the lower plate, and the lower plate having mounting projections extending from a lower surface of the lower plate to be at least partially received by aligned mounting apertures on the top cover to securely mount the lower plate to the top cover of the hydrant monument.

According to a further aspect of the invention there is provided a method of surveying comprising: (a) attaching a survey instrument to a hydrant monument having a reference point, the reference point having a position that is known in at least a 2 dimensional non-vertical space; and (b) sighting from the reference point onto a survey target.

According to a still further aspect of the invention there is provided a method of surveying comprising sighting with a survey instrument onto a survey target, the survey target secured to a tribrach, the tribrach secured to a hydrant monument having a reference point, wherein the position of the reference point is known in at least 2 dimensional non-vertical space.

According to another aspect of the invention there is provided a method of surveying comprising: (a) locating a hydrant monument; (b) mounting a survey instrument to a support plate, the support plate having an upper surface and a lower surface; and (c) mounting the support plate with the survey instrument attached thereto to the hydrant monument.

According to a further aspect of the invention there is provided a method of surveying comprising: (a) locating a hydrant monument; and (b) mounting a survey instrument having an upper plate connected to the lower plate so that the upper plate can be leveled relative to the lower plate, to the hydrant monument.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is an exploded upper perspective view of a first embodiment of a hydrant monument and support plate detached from the hydrant;

FIG. 1A is a lower perspective view of the support plate of FIG. 1 in isolation;

FIG. 1B is a perspective view showing an embodiment of the survey indicia of the hydrant monument shown in FIG. 1;

FIG. 2 is a perspective view of part of the hydrant monument of FIG. 1, with the support plate mounted thereto;

FIG. 2A is a partial cross-section view of the support plate mounted on the hydrant monument as shown in FIG. 2 taken along 2A-2A;

FIG. 3 illustrates an exploded perspective view of a hydrant monument like that in FIG. 1, with a support plate elevated above the hydrant using standoff rods;

FIG. 3A illustrates a support bracket that may be used with standoff rods;

FIG. 4 shows an exploded perspective view of a second embodiment of a support plate and hydrant monument;

FIG. 4A shows a bottom plan view of the embodiment shown in FIG. 4;

FIG. 5 shows a perspective view of an embodiment of an attachment device;

FIG. 6 shows a bottom plan view of the attachment device shown in FIG. 5;

FIG. 7 shows a third embodiment of the hydrant monument and support plate;

FIG. 7A shows the embodiment of FIG. 7 having a support plate mounted using standoff rods;

FIG. 8 shows the embodiment shown in FIG. 7 with a securing strap;

FIG. 9 shows a lower perspective view of a fourth embodiment;

FIG. 10 shows a side view of the embodiment shown in FIG. 9;

FIG. 11 is a top view of a tribrach without an optical plummet;

FIG. 12 is a lower perspective view of a tribrach;

FIG. 13 is a perspective view of a total station attached to a tribrach and adapted to be mounted on a hydrant monument;

FIG. 14 is a perspective view of a single prism target and fine level adapter attached to the embodiment shown in FIGS. 9 and 10;

FIG. 15 is a perspective view of another embodiment of a securing device.

### DETAILED DESCRIPTION

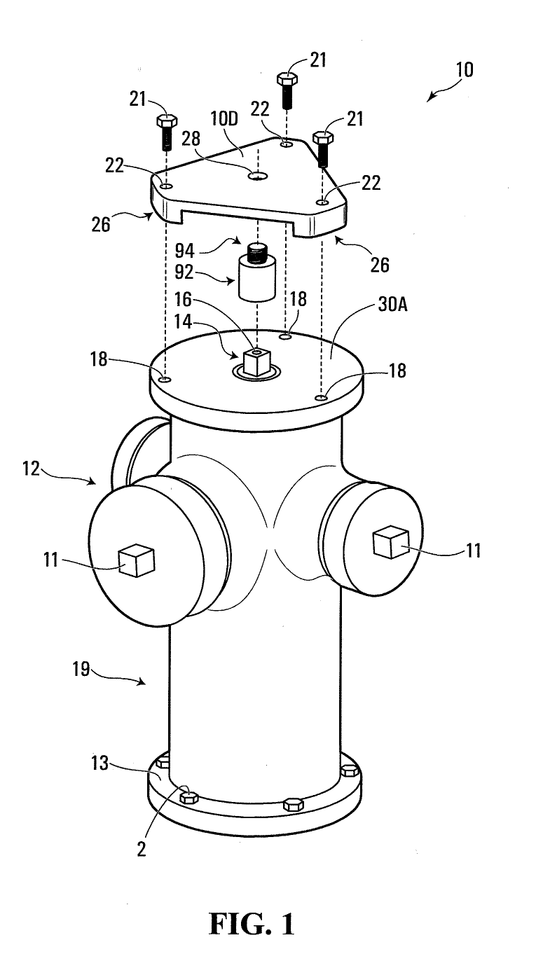

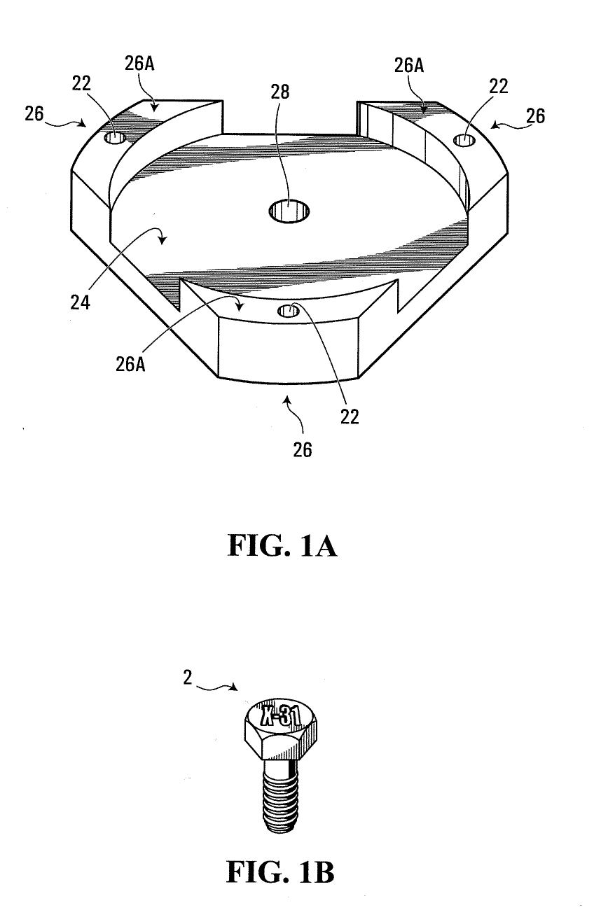

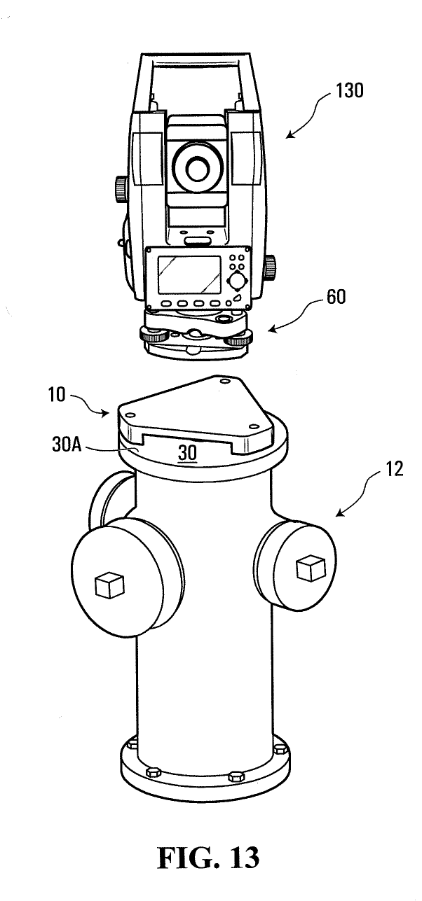

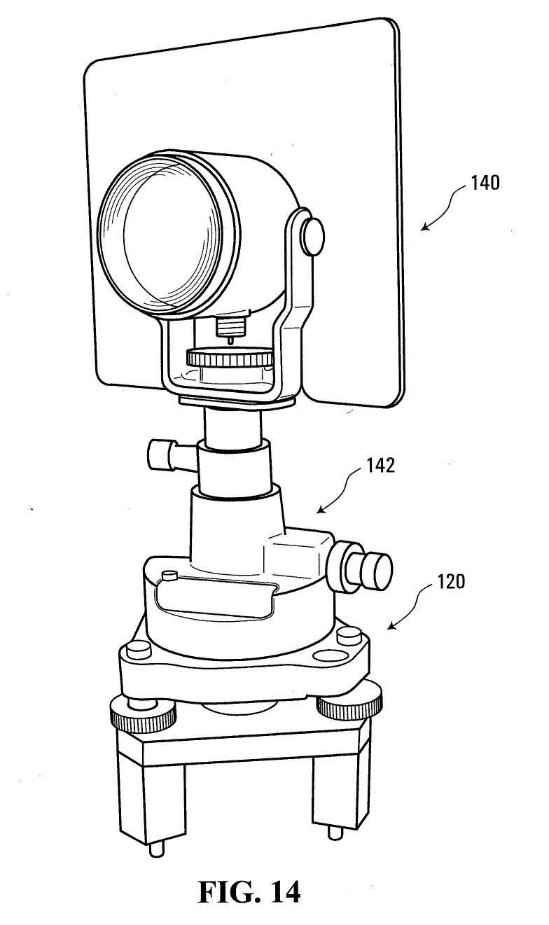

With reference to FIGS. 1-3, a support plate 10 is illustrated that may be generally triangular in shape. Plate 10 may be configured so it can be mounted to a hydrant monument 12 and be used for mounting survey equipment to the upper surface 10D of plate 10. Survey equipment may comprise survey instruments, such as total station 130 (FIG. 13), or survey targets, such as single prism target 140 (FIG. 14). Plate 10 may be made from any suitable material such as by way of example only a metal such as steel, aluminum, or a white metal alloy.

Hydrant monument 12 may be generally constructed using a conventional fire hydrant that may be interconnected to a municipal or private water supply system. An example of a suitable hydrant may be a model D67M-P fire hydrant made by Clow Canada. Hydrant monument 12 may have an operating nut 14 to control the supply of water to nozzle caps 11. Nozzle caps as used hereinafter may refer to pumper caps or hose caps of hydrant monument 12.

Hydrant monument 12 may be configured with a top cover 30 that retains the operating nut 14 and protects the interior of the hydrant. Top cover 30 may have an upper surface 30A that is generally flat to facilitate installation of support plate 10. Generally, the barrel portion 19 of hydrant monument 12 is oriented vertically or very close to vertically, facilitating the accurate setup of survey equipment over a survey reference point on hydrant monument 12.

Plate 10 may have an attachment aperture 28 to receive an attaching device, such as attachment device 92, so that a portion of attachment device 92 extends through the attachment aperture 28 above upper surface 10D of plate 10 and can be connected to a survey instrument.

The lower surface of plate 10 may have a recessed area 24, extending from and surrounding attachment aperture 28. Downwardly extending mounting flanges 26 may be formed at the interface with the recessed area 24 with generally flat lower surfaces 26A. This may provide flush contact with the upper surface 30A of top cover 30 of hydrant monument 12, when the plate 10 is installed on hydrant monument 12. The precise dimensions or configuration of the mounting flanges 26 may not be critical, although flush contact with the top 30 of the hydrant monument 12 may facilitate efficient set up of survey equipment when the upper surface of top 30 is generally flat.

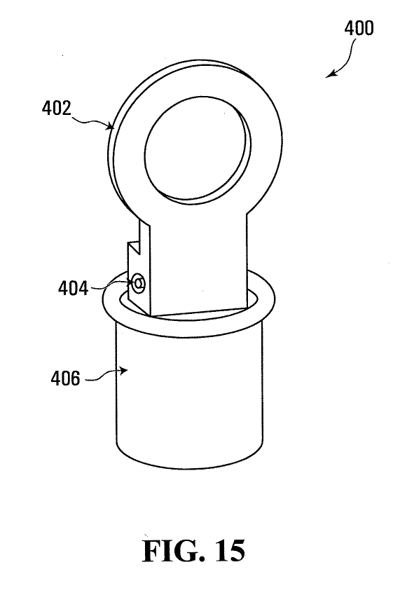

Plate 10 may also have securing apertures 22 generally aligned with corresponding mounting apertures 18 on hydrant monument 12. A securing device, such as bolt 21 or unthreaded pin (not shown), plug (FIG. 15), or quick release bolt may be received by each securing aperture 22 and corresponding mounting aperture 18 to mount plate 10 on hydrant monument 12. Securing apertures 22 and mounting apertures 18 may be threaded to receive bolts 21 having compatible threading. Similarly, when standoff rods 50 are used mounting apertures 18 may be threaded to receive ends 53 of standoffs rods 50 having compatible threads.

Securing apertures 22 may be configured to be located proximate the vertices of a triangle, for example an equilateral triangle, offset from the vertices 10A, 10B and 10C of mounting plate 10, where mounting plate 10 has a generally triangular shape. Configuring the securing apertures 22 in an equilateral triangle assists in ensuring that the monument plate 10 provides a stable base for the attachment of surveying equipment, and in particular survey instruments, such as total station 130.

In some embodiments, securing apertures 22 may be oversized such that even with bolts received through apertures 22 in to apertures 18 in cover 30, plate 10 may be moved transversely relative to surface 30A of top cover 30. However, it will be appreciated that the position of apertures 18 relative to opening 28 may in some embodiments determine where opening 18 will be transversely positioned.

Top cover 30 may have a generally flat upper surface 30A, which may assist in providing a stable platform to mount plate 10. However, hydrant monument 12 may not have a top cover 30 with a generally flat upper surface 30A, possibly requiring modifications to mounting plate 10 and/or to the hydrant 12 to ensure adequate performance.

Operating nut 14 may be located extending through top cover 30 of hydrant monument 12 and may extend vertically upwards from the upper surface 30A thereof. Operating nut 14 is typically located at or proximate the center of top cover 30. Operating nut 14 may have a hollow channel 16 with an upper opening that may act as a lubricating port.

The hydrant monument 12 may have a survey reference or control point or location thereon, and such survey reference or control point may include survey indicia to identify the same. A point on the upper surface of operating nut 14 (or the center thereof) may serve as the survey reference point for hydrant monument 12, the position of which may be known in at least 2 dimensional non-vertical space. The precise elevation of the upper surface of operating nut 14, acting as a survey reference or control point, may also be known to a surveyor or may be determined with reference to other monuments having known vertical elevations. The reference point may be the center of the top surface of operating nut 14. In, other examples, the reference point may be at another location on the hydrant.

The term “survey indicia” as used herein refers to information associated with a reference point that may be of value to a surveyor, such as an identifier that is uniquely associated with the reference point to permit a surveyor to ascertain the coordinates of the reference point. Similarly, survey indicia may also refer to the coordinates of the reference point itself, in embodiments where this is directly associated with a particular reference point in the field. For example, bolt 2 may be secured to base flange 13 as shown in FIG. 1B and may have markings to uniquely identify a reference point, allowing a surveyor to ascertain the position of the reference point. In this case, the markings on bolt 2 would be survey indicia associated with hydrant monument 12.

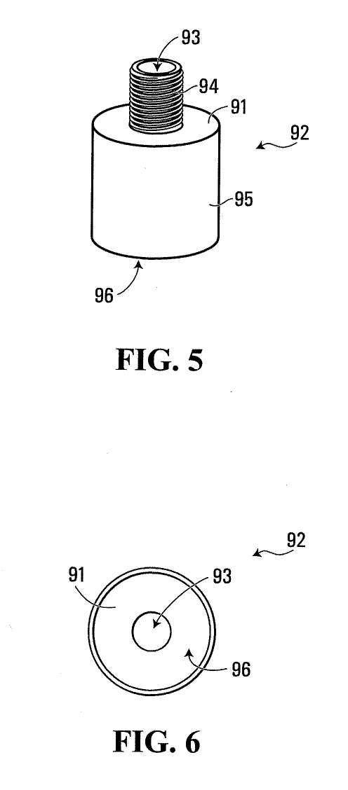

Attachment device 92 may be employed to secure a survey instrument or a survey target to plate 10. As shown in FIGS. 5 and 6, attachment device 92 may have a securing end 94 to secure survey equipment, which may be mounted on a tribrach 60, to plate 10. An example of a commercially available tribrach that may be utilized are models ATR 95001 or ATR 95002 made by Sokkia. Securing end 94 of attachment device 92 may have a diameter smaller than attachment aperture 28. In some embodiments this may permit fine transverse position adjustment of survey equipment, such as total station 130, to ensure that the survey equipment is centered over the operating nut 14 and the reference point thereon. For example, when standoff rods 50 are used the transverse position of the attachment device 92 may not be dictated by being positioned over the operating nut 14. Additionally, if securing end 94 of attachment device 92 has a diameter smaller than attachment aperture 28, this may ensure that aperture 28 does not impede the positioning of attachment device 92 on operating nut 14, thus allowing attachment device, and the survey instrument attached thereto, to be appropriately positioned relative to the reference point.

Securing end 94 may have a hollow interior channel 93 so that one can see through attachment device 92 along a longitudinal axis. Hollow interior channel 93 permits one to see through attachment device 92 from above to allow a surveyor to look through an optical plummet (not shown) to center a survey instrument over a reference point by moving attachment device 92 horizontally within aperture 28. An optical plummet may be included as part of a tribrach or other equipment such as a total station or fine leveling adapter. Securing end 94 may also be threaded to secure survey equipment.

Attachment device 92 may also have a supporting end 95 that may have a hollow interior cavity 96 to receive operating nut 14. Hollow interior cavity 96 may be sized so that operating nut 14 may be snugly received within cavity 96 while permitting independent rotation of attachment device 92 relative to operating nut 14. Permitting both operating nut 14 and attachment device 92 to both rotate but independent of each other, assists in preventing undesirable rotation of attached survey equipment upon rotation of operating nut 14.

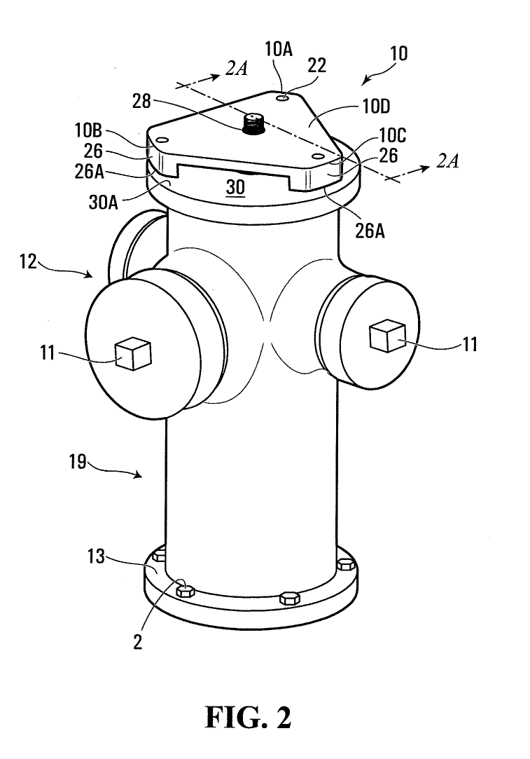

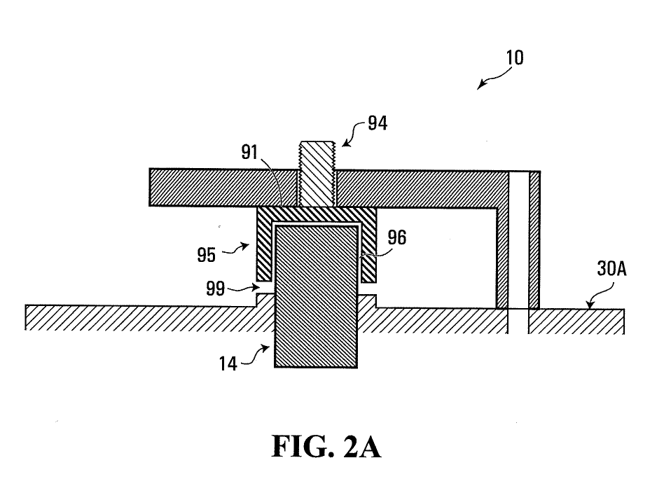

With reference to FIG. 2A, a support surface 91 may be defined at the intersection of securing end 94 and supporting end 95, where supporting end 95 has a diameter larger than securing end 93. The depth of hollow interior cavity 96 may be slightly or significantly less than the height of operating nut 14 so that the attachment device 92 does not contact the top surface 30A of hydrant monument cover 30. A gap 99 between the top surface 30A of hydrant cover 30, and the bottom of supporting end 95 may for example be in the range of % to 1 inch, to allow a wrench to be inserted by a fireman to turn operating nut 14, to activate the fire hydrant. Additionally, the top of operating nut 14 may be configured in relation to the position of attachment device 92 so that the top of operating nut 14 does not contact support surface 91 when survey equipment is mounted to plate 10.

Attachment device 92 may be positioned so that operating nut 14 is received by cavity 96 and securing end 94 extends through attachment aperture 28, so that securing end 94 extends above upper surface 10D of plate 10. Attachment device 92 may then secure a survey instrument or survey target, typically using a tribrach, to plate 10. When survey equipment is secured to plate 10 using attachment device 92, support surface 91 may make secure and flush contact with recessed area 24 on the lower surface of plate 10 to provide a stable mount that inhibits rotation of the attached survey equipment. Such a configuration of attachment device 92 also facilitates independent rotation of attachment device 92 and operating nut 14. The positioning of the attachment device 92 on operating nut 14 may itself serve to properly transversely position the survey instrument attached to device 92 over a reference point on hydrant monument 12, such as on operating nut 14.

Additionally, the position of apertures 18 relative to opening 28 can be configured such that opening 18 will be transversely positioned appropriately to allow attachment device 92 to be received on operating nut 14 so that device 92 is positioned over the reference point.

Attachment device 92 allows survey equipment to be mounted more robustly to hydrant monument 12 using plate 10. Secure mounting of survey instruments and sophisticated survey targets is important to ensure the proper position and orientation is maintained, particularly given the weight of the instruments. A survey instrument or survey target may be said to be securely mounted when it is secured so that its base is stable in a generally horizontal plane and so that rotation of its base about a vertical axis is inhibited or prevented. Preventing rotation about a vertical axis of survey instruments and targets is important when conducting a survey to maintain proper orientation and to permit the precise measurement of angles between reference points when using a survey instrument. Upon rotation of a survey instrument or survey target, proper orientation is lost and the correctness of subsequent measurements is negatively impacted affecting the accuracy of the survey. For example, if a survey instrument improperly rotates by 5 degrees during use, points that are in reality 45 degrees apart may be measured as only being 40 degrees apart. Similarly, even very small rotations of a survey instrument may introduce significant errors when surveying over large distances.

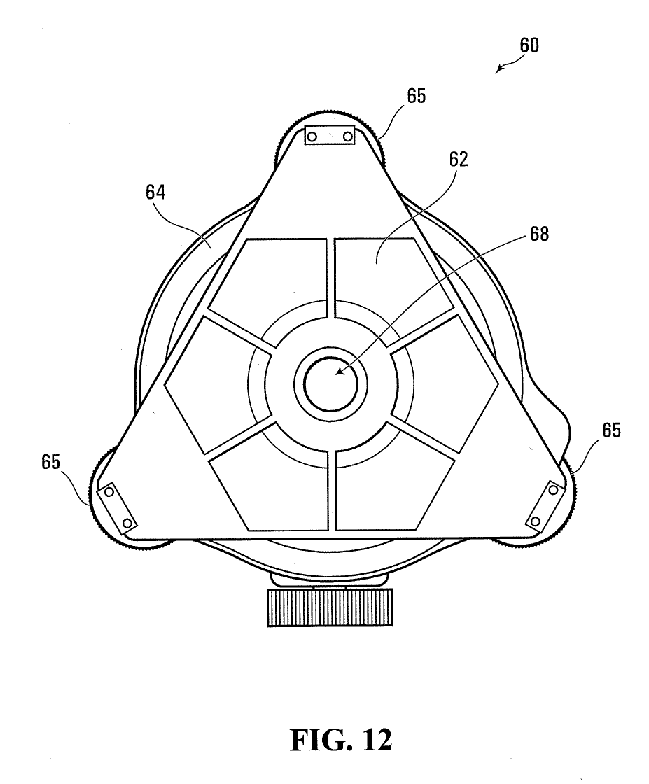

To secure survey equipment to plate 10, survey equipment may be placed on upper surface 10D. Attachment device 92 may then be inserted through attachment aperture 28, so that securing end 94 may be received by an aperture formed in the survey equipment to be mounted. For example, securing end 94 may be received in an aperture 68 of tribrach 60 (FIG. 12), with tribrach 60 having survey equipment mounted to it, as described below. A secure mount of plate 10 to tribrach 60 and survey equipment attached to tribrach 60, may be achieved by threading securing end 94 into aperture 68 until the lower surface 62 is firmly held against upper surface 10D of plate 10 so that a stable mount that inhibits rotation about a vertical axis is provided.

Once survey equipment is secured to plate 10, plate 10 may be attached to hydrant monument 12 by placing plate 10 on top cover 30 so that cavity 96 of attachment device 92 receives operating nut 14, and securing plate 10 is secured to top 30 with bolts 21. Bolts 21 may be threaded through securing apertures 22 and mounting apertures 18 each having compatible threads. Alternatively, in some applications/embodiments, bolts 21 may not be threaded and simply inserted into securing apertures 22 and corresponding mounting apertures 18 to provide a stable mount of plate 10 to hydrant monument 12. In this way, the survey equipment will have its base secured so that its orientation will not change from a desired generally horizontal plane orientation and inhibit rotation of survey equipment about a vertical axis.

It may be important to ensure that when plate 10 is secured to tribrach 60, that the transverse position of attachment device 92 relative to plate 10, will allow the plate to be mounted to cover 30. Thus, the tolerances may be such that the transverse position of attachment device 92 is substantially defined by passing through aperture 28 in plate 10. In other embodiments, the attachment device may not have its transverse position secured (e.g. it is not tightened to plate 10) until after plate 10 has been mounted to the hydrant cover 30. Thus a gap may be provided between plate 30 between flanges 26 that is sufficient to permit either an individuals fingers or a suitable tool to engage the attachment device to secure the attachment device to the plate 10 and tribrach 60, when attachment device is mounted on operating nut 14.

Other forms of securing devices may also be used to secure plate 10 to hydrant monument 12. For example, a quick release plug 400 (FIG. 15) may be used to secure plate 10 to hydrant monument 12 to provide a stable mount that inhibits rotation. Expandable end 406 may be inserted through securing apertures 22 and at least partially received in mounting apertures 18. Handle 402 may then be pivoted about hinge 404 to cause expandable end 406 to expand within securing apertures 22 and mounting apertures 18 to provide a relatively secure mount. Devices such as plug 400 are readily available and are not described in further detail herein. Alternatively, quick insertion and release bolts, such as those described in U.S. Pat. No. 4,478,546, the contents of which are hereby incorporated herein by reference, may be used to secure plate 10 to hydrant monument 12. Having securing devices that enable plate 10 to be quickly and easily removed may be advantageous as it permits ready access to operating nut 14 to activate the flow of water from hydrant monument 12 in emergency situations. The ability to quickly and easily remove plate 10, may assist to alleviate regulatory concerns that may otherwise limit the use of plate 10 in surveying using hydrant monuments.

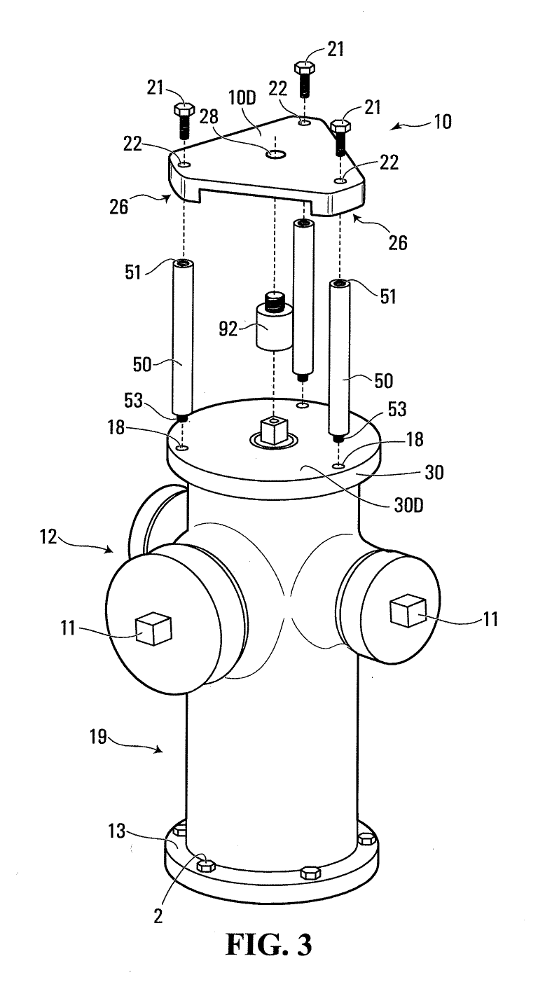

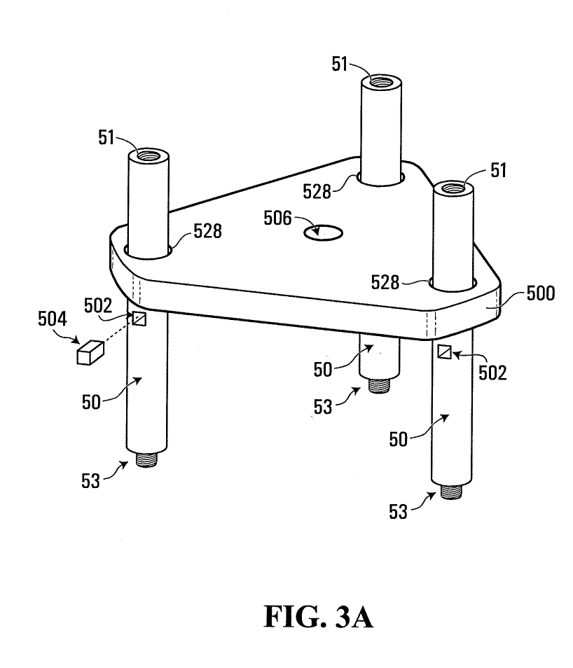

In other embodiments, standoff rods 50 (FIG. 3) may be used to elevate plate 10 above the top cover 30 of hydrant monument 12. Standoff rods 50 may have ends 53 compatible with mounting apertures 18 to secure standoff rods 50 to hydrant monument 12. Standoff rods 50 may also have apertures 51 to receive securing devices, such as bolts 21, each having compatible threads. Plate 10 may be secured to standoff rods 50 by placing bolts 21 through securing apertures 22 and into apertures 51 of standoff rods 50 to attach plate 10 to standoff rods 50 and thereby to hydrant monument 12.

It may be desirable to have plate 10 elevated above the top cover 30 of hydrant monument 12 to make it easier for the surveyor to take measurements using a survey instrument, such as total station 130. Similarly, the terrain surrounding a hydrant monument 12 may require monument plate 10 be elevated such as, for example, where the terrain is particularly hilly, or when a snow bank would otherwise obstruct a surveyors line of sight to a survey target. Standoff rods 50 should be of a sufficient diameter and constructed from a suitable material to ensure that plate 10 is sufficiently stable to permit a surveyor to take accurate measurements using an attached survey instrument. While three standoff rods 50 are ideal, more than three rods could be employed to further secure the plate 10 to hydrant monument 12.

In another method of attaching plate 10 to hydrant monument 12 when using standoff rods 50, standoff rods 50 may first be secured to hydrant monument 12 by securing ends 53 in mounting apertures 18. Plate 10 may then be secured to standoff rods by placing bolts 21 through securing apertures 22 to be received in ends 51. Survey equipment may then be placed on upper surface 10D. Attachment device 92 may then be inserted through attachment aperture 28 and received by an aperture of the survey equipment to be secured. For example, securing end 94 may be received by aperture 68 of tribrach 60 when a tribrach is used to secure survey equipment to plate 10.

Attachment device 92 may be used to center a survey instrument over the operating nut 14 and to secure the survey instrument to plate 10. Centering of a survey instrument over operating nut 14 may be possible using attachment device 92 in circumstances where the diameter of securing end 94 is smaller than the diameter of attachment aperture 28 and thus end 94 can be moved transversely within aperture 28. An optical plummet (not shown) which is often part of a known tribrach or other survey equipment may be used to facilitate centering over operating nut 14. A surveyor may look through the hollow interior of attachment device 92 and position the survey equipment so that it may be centered over a reference point, such as a reference point on the top of operating nut 14. When standoffs are employed, the ability to center survey equipment over a reference point may be of increased importance compared to embodiments where plate 10 is mounted closer to top cover 30.

As illustrated in FIGS. 3 and 3A, depending upon the length and design of standoff rods 50, it may be desirable to have a supplementary supporting apparatus, such as a support bracket 500 located between plate 10 and top cover 30 to provide additional stability. Support bracket 500 may have apertures 528 to receive standoff rods 50. Support bracket 500 may also have an aperture 506 to facilitate centering over a reference point using an optical plummet. Where desired for use with support bracket 500 standoff rods may have apertures 502 for insertion of a support 504. To mount plate 10 using standoffs and support bracket 500, standoffs may first be secured to hydrant monument 12 as previously described. Supports 504 may then be placed into apertures 502. Standoff rods 50 may then be inserted into apertures 528 of support bracket 500 and support bracket 500 lowered into position to be supported by supports 504. Other methods of and devices for providing additional support for plate 10, may also be used in particular applications.

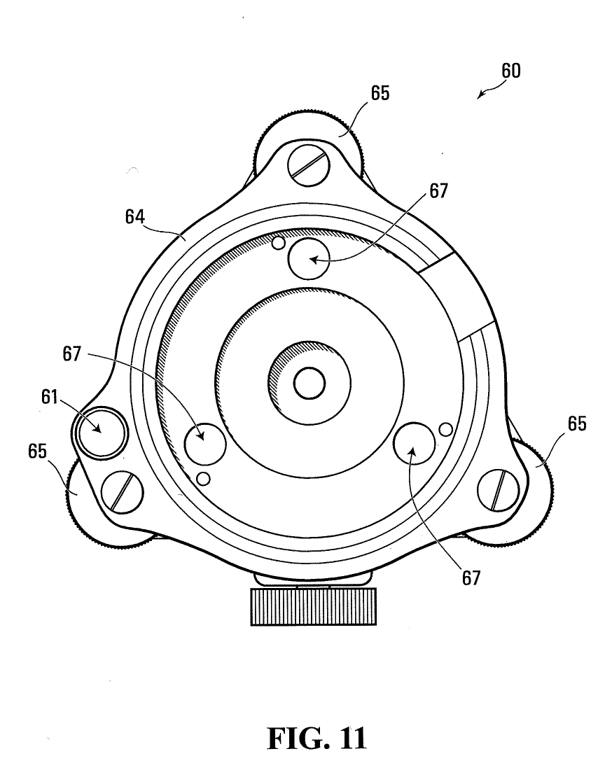

Survey equipment, such as survey instruments and targets, are often mounted upon a tribrach. The tribrach is then typically secured to a tripod (not shown) to position the survey instrument or target for use in the field. An exemplary tribrach 60 is shown in FIGS. 11 and 12. Tribrach 60 has an upper plate 64 connected to lower plate 62 with three bolts having thumb screws 65 to allow adjustment. Adjusting thumb screws 65 allows upper plate 64 to be moved relative to lower plate 62 permitting upper surface 64 to be leveled. Upper surface 64 may also have a leveling device 61 to assist in leveling upper surface 64. Both the upper plate 64 and lower plate 62 are typically triangular to provide a stable platform for survey equipment.

Lower plate 62 of tribrach 60 may have an aperture 68 to secure tribrach 60 to plate 10. Aperture 68 may be threaded to receive securing end 94 of attachment device 92 having corresponding threads to secure lower surface 62 to plate 10. Lower surface 62 may be secured to plate 10 so that lower surface 62 of tribrach 60 is flush mounted on upper surface 10D of plate 10 to provide stability. Survey equipment such as a total station 130 may be secured to upper surface 64 by inserting projections (not shown) of survey equipment into apertures 67 and clamping projections securely in place according to known methods.

Ensuring that a level surface is provided is particularly important for survey instruments, such as total station 130 and sophisticated survey targets. Permitting survey equipment to be mounted on a hydrant monument 12 using tribrach 60 is one method of providing a stable platform that may be leveled. Mounting survey equipment using tribrach 60 is advantageous because tribrachs are widely used by surveyors and existing equipment may be readily adapted for use with plate 10 to mount to hydrant monument 12. To facilitate the use of a common tribrach 60, securing end 94 may have a ⅝″ diameter and be threaded with 11 threads per inch to be received by aperture 68.

Securing survey equipment to plate 10 using a tribrach such as tribrach 60 is particularly advantageous. As common survey targets and survey instruments are also generally designed to be secured to tribrach 60 it is possible to interchange a survey instrument with a survey target without removing the tribrach from the hyrdant monument. Importantly, when survey instruments or survey targets are interchanged in this manner a high degree of accuracy can be maintained as the survey equipment or survey instrument can be supported in the same position.

General methods of surveying are well known in the art, and are not described in detail hereinafter. A surveyor wishing to conduct a survey may attach a survey instrument over a reference point of hydrant monument 12. A survey instrument may be attached to a hydrant monument 12, for example, using plate 10 and tribrach 60. Once a survey instrument is attached to a hydrant monument 12 having a position known in 2 dimensional vertical space, a surveyor may sight from a reference point on a hydrant monument 12 to a survey target. The survey instrument attached to a hydrant monument 12 may be, for example, a total station 130. Additionally, a surveyor may sight to a target from the reference point, when the position of the reference point is also known in a vertical direction to assist in making a survey.

With reference to FIG. 14, similarly, survey targets, such as a single prism target 140 may be attached to a reference point on a hydrant monument 12, where the position of the reference point may be known in at least 2 dimensional space. A surveyor may then sight to the target attached to a reference point of a hydrant monument 12 to assist in making a survey.

Modifications to plate 10 may be made where the upper surface 130a of top cover 130 of a hydrant monument 112 is not flat or approximately flat. Many existing hydrant monuments 112 have top covers 130 that are not generally flat but are otherwise suitable for the attachment of survey equipment and use as a reference point by a surveyor.

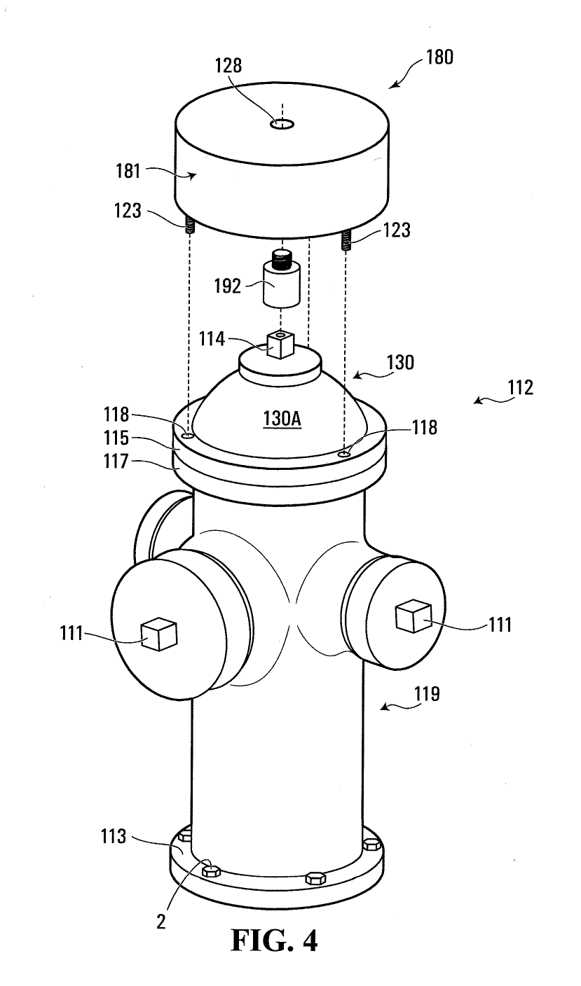

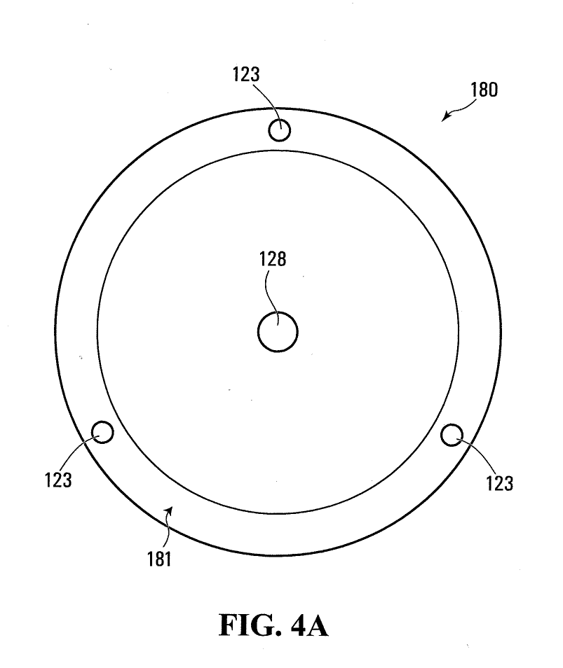

Support plate 180 as shown in FIG. 4 is suitable for attachment to a hydrant monument 112 having a curved or domed top cover 130 and flange 115 as part of top cover 130. Plate 180 is preferable for use with survey targets although certain types of survey instruments may also be used with plate 180.

Additional details of an exemplary hydrant monument 112 having a curved top cover 130 are shown in FIG. 4. Flange 115 may be located at the bottom of top cover 130 and make flush contact with flange 117 of barrel portion 119 so that apertures (not shown) on flanges 115 and 117 are aligned. In this manner, top cover 130 may be secured to barrel portion 119 using bolts (not shown) received in the apertures in a conventional manner. Mounting apertures 118 may be located on flanges 115 and 117 to receive securing devices, such mounting protrusions 123 extending from sidewall 181, to facilitate secure mounting of support plate 180 on flange 115. Alternatively, support plate 180 may be modified to have securing apertures (not shown) extending through sidewall 181 so that bolts (not shown) may be inserted through securing apertures and received by mounting apertures 118 to secure support plate 180 to flange 115.

Attachment device 192 may be used to secure survey equipment, such as a survey target, using tribrach 60 as previously described with reference to attachment device 92, before mounting support plate 180 to hydrant monument 112. Attachment device 192 may be similar to attachment device 92 or may be modified for particular applications. Survey equipment may be placed on the upper surface of support plate 180 and secured with attachment device 192, as previously described with reference to plate 10. Support plate 180 may then be placed on hydrant monument 112 so that mounting projections 123 are received by apertures 118 to prevent rotation of support plate 180 and provide a stable base for use with certain types of survey equipment. However, the tribrach may be used as an intermediary between top plate 180 and the survey equipment.

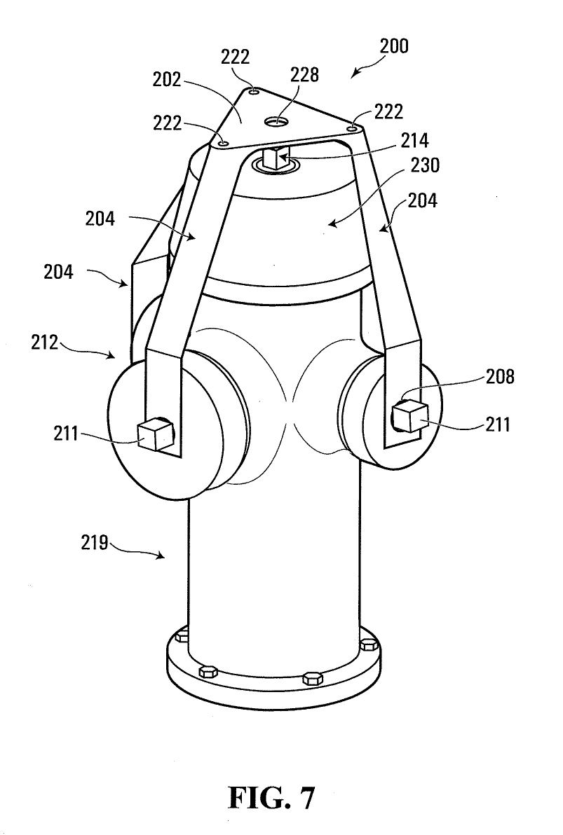

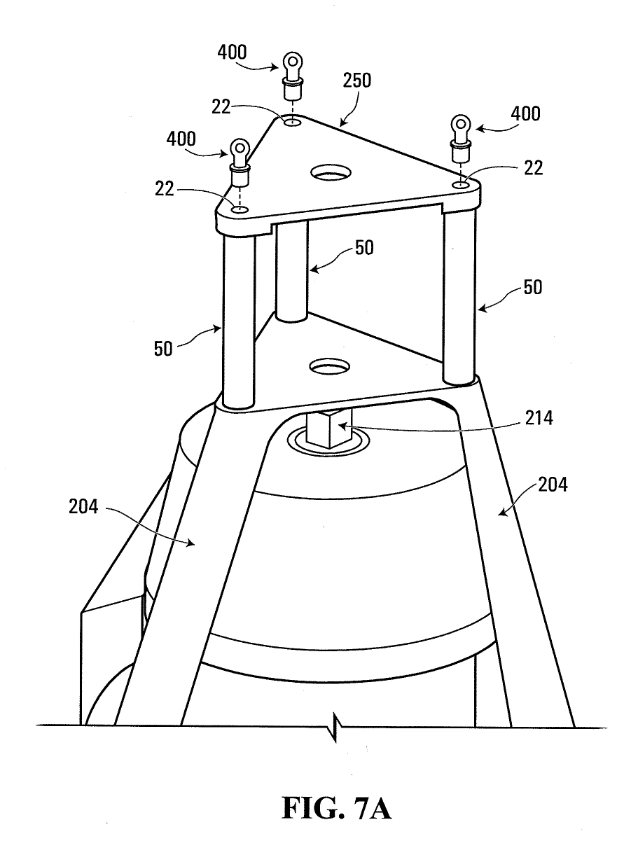

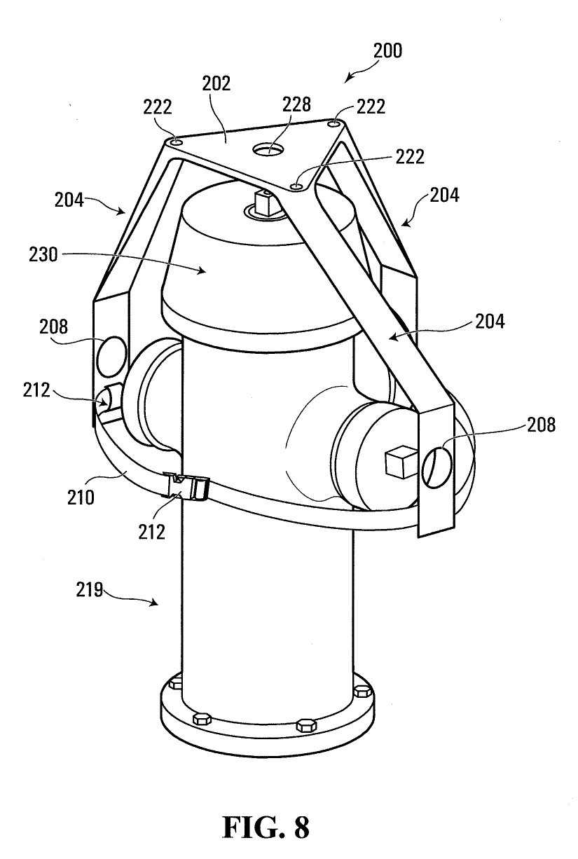

Support plate 200, shown in FIGS. 7 and 8, is another embodiment suitable for securing survey equipment to a hydrant monument 212, including hydrant monuments having curved or domed tops. Support plate 200 may have an attachment aperture 228 to receive an attachment device, (not shown) to secure survey equipment. A survey instrument, such as total station 130, or a survey target, such as single prism target 140, may be secured to plate 200 using an attachment device such as attachment device 92 as previously described with reference to plate 10. Specifically, an attachment device could be placed over operating nut 214 and make flush contact with the lower surface of support plate 200 to center survey equipment over operating nut 214 and provide a stable mount that permits independent rotation of the attachment device and operating nut 214, while providing a stable mount that also inhibits rotation of the attached survey equipment.

Plate 200 may have an upper surface 202 and attachment arms 204. The attachment arms 204 may extend downward and may each have a nozzle aperture 208 to receive nozzle caps 211 of hydrant monument 212. Attachment arms may be secured in place by any suitable means such as a pin in each hole of each cap 211 (not shown). Attachment arms 204 may thus secure plate 200 to hydrant monument 212 to provide a stable mounting platform for survey equipment, particularly survey instruments.

As shown in FIG. 8, a stability strap 210 may extend around the barrel 219 of hydrant monument 212 and may be connected to each attachment arm 204 to increase the stability of plate 200 when mounted to hydrant monument 212. Strap 210 may also have a buckle 212 to permit strap 210 to be tightened to assist in providing a stable plate 200. Alternatively, a stability strap having caps to receive nozzle caps 211 could be employed and tightened. Further details of a suitable strap having caps to receive nozzle caps 211 is described in U.S. Pat. No. 6,691,732, the contents of which are hereby incorporated herein by reference.

As shown in FIG. 7A, plate 200 may also have securing apertures 222 when it is desired to elevate survey equipment above top cover 230 of hydrant monument 212. This may be accomplished using standoff rods 50. Securing apertures 222 may receive ends 53 of standoff rods 50 to secure standoff rods 50 to plate 200 to provide a base for the attachment of an elevated support plate 250. Elevated support plate 250 may be similar to plate 10 previously described. Plate 250 may then be secured using bolts 21 received by securing apertures 22 and apertures 51 to secure plate 250 to standoff rods 50. Other securing devices as described above may also be used to secure plate 250 to standoff rods 50. Survey equipment and plate 250 may then be mounted as previously described with reference to plate 10 when standoff rods 50 are used. Where plate 200 is not desired for use with standoff rods 50, securing apertures 222 may not be present.

Monument plate 200 and attachment arms 204 may be constructed of a material, such as for example aluminum or stainless steel to ensure the upper surface 202 of monument plate 200 provides a stable and rigid surface for the attachment of a survey instrument, such as total station 130. For example, plate 200 could be comprised of aluminum ¼ inches thick and having attachment arms of the same thickness that are 2.5 to 3 inches wide and provide acceptable performance in certain applications.

Alternatively, support plate 200 may be secured to hydrant monument 212 using only 2 attachment arms. Attachment arms may be generally the same as attachment arms 204, except that the thickness and width may need to be modified to provide sufficient stability for particular applications. Persons skilled in the art will appreciate that using 3 attachment arms provides greater stability, however, the use of 2 attachment arms may be suitable for certain applications and may reduce manufacturing costs.

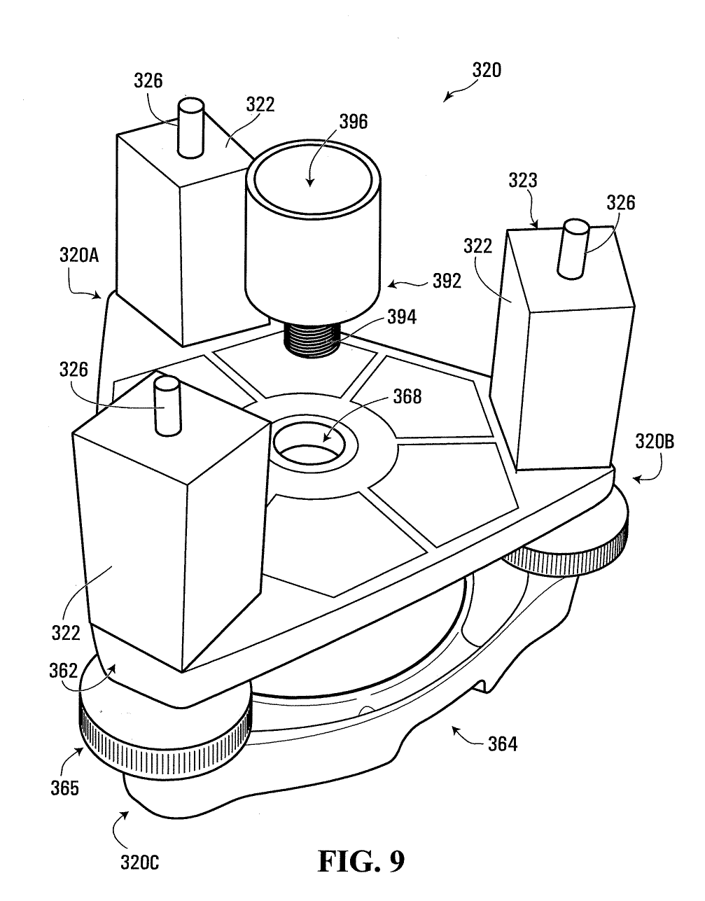

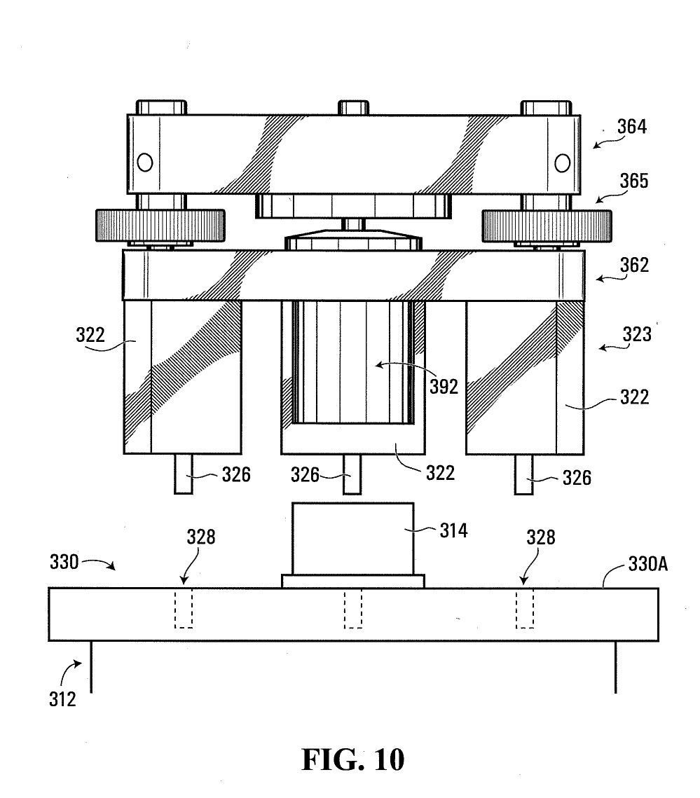

Another embodiment suitable to secure survey equipment to a hydrant monument is illustrated in FIGS. 9 and 10. In this embodiment, a support device 320 is comprised of a tribrach that may be mounted directly upon the upper surface 330A of top cover 330 of a hydrant monument 312. The support device may have a modified lower plate 362 suitable to provide a stable platform when mounted to a generally flat upper surface 330A of hydrant monument 312.

Support device 320 has an upper plate 364 and lower plate 362 connected by thumb screws 365. Adjustment of thumb screws 365 adjusts upper surface 364 relative to lower plate 362 allowing upper plate 364 to be leveled, in the same manner as a traditional tribrach. Survey equipment may be secured to the upper surface 364 of the tribrach as previously described in relation to FIGS. 11 and 12.

Lower plate 362 may have downwardly extending mounting projections 323 extending to securely mount said support device 320 to upper surface 330a of hydrant monument 312. Mounting projections 323 may securely mount support device 320 by abutting upper surface 330A of hydrant monument 312 to provide support and/or inhibit rotation of lower surface 362. Mounting projections 323 may be mounting flanges 322 having pins 326.

As illustrated in FIGS. 9 and 10, mounting flanges 322 may extend from lower surface 362 and make flush contact with upper surface 330A of top 330 when attachment device 320 is placed on upper surface 330A of hydrant monument 312. The precise configuration of mounting flanges 322 may vary. However, positioning mounting flanges 322 at or near vertices 320A, 320B, and 320C of generally triangular plate 362 may increase stability. Pins 326 may also extend from the lower surface of mounting flanges 322. Pins 326 may be received by corresponding apertures 328 located on at upper surface 330A of top 330 of hydrant monument 312 to assist in providing stability and inhibit rotation of support device 320. Again, the precise configuration of apertures 328 and pins 326 may vary and provide a secure mounting of device 320 to hydrant monument 312. Alternatively, mounting projections 323 may be pins 326 extending from lower surface 362 and received by apertures 328 without having mounting flanges 322 with suitable modification. Mounting projections 323 may be modified in other ways provided a means to securely mount and inhibit rotation of attachment device 320 is achieved.

As an additional measure to secure the plate 362 to top cover 330 for hydrant monument 312, securing end 394 of attachment device 392 may be received by aperture 368 located on lower plate 362. Attachment device 392 may be similar to attachment device 92. Securing end 394 and aperture 368 may have corresponding threads to permit secure attachment. Attachment device 392 may be positioned so that interior cavity 396 is placed over operating nut 314 and have securing end 394 inserted into aperture 368 to center securing device 320 over operating nut 314 to facilitate placement of survey equipment over a reference point in a manner similar to that previously described with reference to attachment device 92 and plate 10.

To use support device 320, survey equipment may first be secured to upper surface 364, in a similar manner to as described above with reference to tribrach 60. Attachment device 392 may then be threaded into attachment aperture 368. Support device 320, with survey equipment secured thereto, may then be placed on top 330 so that mounting projections 323 may be received by apertures 328 and operating nut 14 is received within attachment device 392. Attachment device 392 may have a cavity to receive operating nut 314 in a similar manner to attachment device 92.

Support plate 10 and other embodiments of the support plate or support device 320 may also be adapted to receive a GPS unit as one particular type of survey equipment. The use of a GPS receiver tied to a hydrant monument 12 with a known physical location may be used as a base station and may permit a GPS unit to initialize faster with fewer satellites, according to known methods.

Securing a GPS unit to a hydrant monument 12 is advantageous compared to securing a GPS unit to a tripod. Often GPS units are setup for extended periods of time where the surveyor is not in the immediate area, exposing expensive GPS units to possible theft or vandalism. Securing a GPS unit to a hydrant monument 12 provides a securely fixed platform to secure a GPS unit using for example, a locking cable, to minimize the risk of theft and vandalism.

Various types of sophisticated survey equipment may be mounted to hydrant monuments using the devices described above. For example, total station 130 is shown attached to hydrant monument 12 using plate 10 and tribrach 60 in FIG. 13. Similarly, single prism target 140 and fine level adapter 142 are shown attached to support device 120 in FIG. 14.

Having regard to the foregoing, it will be appreciated that hydrant monuments have significant advantages over conventional survey monuments in providing a platform on which sophisticated survey instruments and survey targets may be mounted.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. An apparatus to secure survey equipment to a top portion of a hydrant monument, said apparatus comprising:
(a) a support plate having an upper surface and a lower surface, said support plate adapted to be securely mounted to said top cover of said hydrant monument; and
(b) an attachment device to secure said survey equipment proximate said upper surface of said support plate.

2. An apparatus as claimed in claim 1 wherein said hydrant monument has upwardly extending operating nut, and wherein said attachment device comprises a portion to engage a portion of said operating nut of said hydrant monument.

3. An apparatus as claimed in claim 1, wherein said support plate comprises an attachment aperture to receive a portion of said attachment device through said attachment aperture, whereby said attachment device is operable to engage said survey equipment to secure said survey equipment at said upper surface of said support plate.

4. An apparatus as claimed in claim 3, wherein said hydrant monument has upwardly extending operating nut, and wherein said attachment device comprises a first end having a cavity to receive at least an end portion of said operating nut of said hydrant monument; and wherein said attachment device comprises a second securing end located opposite said first end, said securing end extending through said attachment aperture to secure said survey equipment to said support plate.

5. An apparatus as claimed in claim 4, wherein said support plate comprises securing apertures aligned with mounting apertures located on said hydrant monument to receive securing devices to secure said support plate to said hydrant monument.

6. An apparatus as claimed in claim 5, wherein said apparatus comprises mounting flanges extending from said lower surface of said support plate to be mounted flush on said top cover of said hydrant monument.

7. An apparatus as claimed in claim 4, wherein said apparatus further comprises mounting protrusions extending from said lower surface of said support plate and being received in aligned mounting apertures on said hydrant monument.

8. An apparatus as claimed in claim 8, wherein said apparatus further comprises at least two attachment arms, said attachment arms extending downward from said upper surface of said support plate and having nozzle apertures to receive nozzle caps of said hydrant monument to secure said support plate to said hydrant monument.

9. An apparatus as claimed in claim 8, further comprising a support strap connected to said attachment arms, said support strap having a buckle to allow said support strap to be tightened to secure said attachment arms on said nozzle caps.

10. An apparatus as claimed in claim 4, wherein said support plate comprises a sidewall portion, said sidewall portion having a mounting protrusion extending from a lower surface of said sidewall portion to be received by an aligned aperture on a flange of said top cover of said hydrant monument to secure said support plate.

11. An apparatus as claimed in claim 4, wherein said survey equipment is secured to a tribrach, and wherein said tribrach is secured to said support plate using said securing end of said attachment device.

12. An apparatus as claimed in claim 3, further comprising at least two standoff rods, each standoff rod having a lower end to be received by a corresponding mounting aperture of said top cover and an upper end having an aperture to receive a securing device to secure said standoff rod to said support plate to elevate said support plate above said top cover.

13. An apparatus as claimed in claim 12, wherein said attachment device has a hollow interior channel to allow centering with an optical plummet.

14. An apparatus as claimed in claim 12 wherein said wherein said central attachment aperture is larger in size than said portion of said attachment device received through said attachment aperture, whereby said attachment device and said survey equipment secured thereto, may be moved transversely to adjust the secured transverse position of said survey equipment relative to said hydrant monument.

15. An apparatus as claimed in claim 14 wherein said hydrant monument has an operating nut extending upwards from said top cover and wherein the secured transverse position of said attachment device may be adjusted to adjust the transverse position of said survey equipment relative to said operating nut.

16. An apparatus as claimed in claim 4, wherein said apparatus further comprises at three attachment arms, said attachment arms extending downward from said upper surface of said support plate and having nozzle apertures to receive nozzle caps of said hydrant monument to secure said support plate to said hydrant monument.

17. An apparatus comprising:
(a) a hydrant monument;
(b) a survey instrument;
(c) a support plate having an upper surface and a lower surface, said support plate adapted to be securely mounted to said hydrant monument; and
(d) an attachment device to secure said survey instrument at said upper surface of said support plate.

18. An apparatus as claimed in claim 17, wherein said support plate comprises a central attachment aperture to receive a portion of said attachment device through said attachment aperture, whereby said attachment device engages said survey equipment to secure said survey equipment at said upper surface of said support plate.

19. An apparatus as claimed in claim 18, wherein said attachment device comprises a first end having a cavity to receive at least an end portion of an operating nut of said hydrant monument; and wherein said portion of said attachment device comprises a securing end located opposite said first end, said securing end extending through said attachment aperture to secure said survey equipment to said support plate.

20. An apparatus as claimed in claim 19, wherein said support plate comprises securing apertures aligned with mounting apertures located on said hydrant monument to receive securing devices to secure said support plate to said hydrant monument.

21. An apparatus as claimed in claim 20, wherein said support plate comprises mounting flanges extending from said lower surface of said support plate to be mounted flush on said top cover of said hydrant monument.

22. An apparatus as claimed in claim 19, wherein said support plate comprises mounting protrusions extending from said lower surface and received in aligned mounting apertures on said hydrant monument.

23. An apparatus as claimed in claim 19, wherein said apparatus comprises at least two attachment arms, said attachment arms extending downward from said upper surface of said support plate and having nozzle apertures to receive nozzle caps of said hydrant monument to secure said support plate to said hydrant monument.

24. An apparatus as claimed in claim 23, further comprising a support strap connected to said attachment arms, said support strap having a buckle to allow said support strap to be tightened to secure said attachment arms on said nozzle caps.

25. An apparatus as claimed in claim 19, wherein said support plate comprises a sidewall portion, said sidewall portion having a mounting protrusion extending from a lower surface of said sidewall portion to be received by an aligned aperture on a flange of said top cover of said hydrant monument to secure said support plate.

26. An apparatus as claimed in claim 18, wherein said survey equipment is secured to a tribrach, and wherein said tribrach is secured to said support plate using said securing end of said attachment device.

27. An apparatus as claimed in claim 18, further comprising at least two standoff rods, each standoff rod having a lower end to be received by a corresponding mounting aperture of said top cover and an upper end having an aperture to receive a securing device to secure said standoff rod to said support plate to elevate said support plate above said top cover.

28. An apparatus as claimed in claim 26, wherein said attachment device has a hollow interior channel to allow centering with an optical plummet.

29. An apparatus as claimed in claim 27 wherein said wherein said central attachment aperture is larger in size than said portion of said attachment device received through said attachment aperture, whereby said attachment device and said survey equipment secured thereto, may be moved transversely to adjust the secured transverse position of said survey equipment relative to said hydrant monument.

30. An apparatus as claimed in claim 29 wherein said hydrant monument has an operating nut extending upwards from said top cover and wherein the secured transverse position of said attachment device may be adjusted to adjust the transverse position of said survey equipment relative to said operating nut.

31. An apparatus as claimed in claim 18, wherein said apparatus further comprises at three attachment arms, said attachment arms extending downward from said upper surface of said support plate and having nozzle apertures to receive nozzle caps of said hydrant monument to secure said support plate to said hydrant monument.

32. An apparatus to secure survey equipment to a hydrant monument comprising:
(a) an upper plate adapted to secure survey equipment to an upper surface;
(b) a lower plate;
said upper plate connected to said lower plate so that said upper plate can be leveled relative to said lower plate; and
said lower plate having an aperture to receive a securing device to secure said lower plate to said hydrant monument.

33. The apparatus of claim 32 wherein said lower plate has mounting projections extending from a lower surface of said lower plate to be at least partially received by aligned mounting apertures on said top cover to securely mount said lower plate to said top cover of said hydrant monument.

34. The apparatus of claim 33 wherein said mounting projections has mounting flanges to abut said top cover of said hydrant monument, said mounting flanges having pins to be received by said aligned mounting apertures of said hydrant monument.

35. An apparatus to secure survey equipment to a hydrant monument comprising:
(a) an upper plate adapted to secure survey equipment to an upper surface;
(b) a lower plate;
said upper plate connected to said lower plate so that said upper plate can be leveled relative to said lower plate; and
said lower plate having mounting projections extending from a lower surface of said lower plate to be at least partially received by aligned mounting apertures on said top cover to securely mount said lower plate to a top cover of said hydrant monument.

36. An apparatus comprising:
(a) a hydrant monument having a top cover;
(b) a survey instrument;
(c) an upper plate adapted to secure said survey instrument to an upper surface;
(d) a lower plate;
said upper plate connected to said lower plate so that said upper plate can be leveled relative to said lower plate, and said lower plate having mounting projections extending from a lower surface of said lower plate to be at least partially received by aligned mounting apertures on said top cover to securely mount said lower plate to said top cover of said hydrant monument.

37. A method of surveying comprising:
(a) attaching a survey instrument to a hydrant monument having a reference point, said reference point having a position that is known in at least a 2 dimensional non-vertical space; and
(b) sighting from said reference point onto a survey target.

38. A method as claimed in claim 37, wherein said reference point is also known in a vertical direction.

39. The method as claimed in claim 38 wherein said survey instrument is mounted to said hydrant monument using a support plate disposed between said hydrant monument and said survey instrument.

40. The method as claim in claim 39, wherein said intermediate support plate is elevated above said hydrant monument using standoff rods.

41. The method as claim in claim 39, wherein said survey instrument is secured to a tribrach and said tribrach is secured to said hydrant monument.

42. A method of surveying comprising sighting with a survey instrument onto a survey target, said survey target secured to a tribrach, said tribrach secured to a hydrant monument having a reference point, wherein the position of said reference point is known in at least 2 dimensional non-vertical space.

43. The method as claimed in claim 42, wherein the position of said target is also known in a vertical direction.

44. A method of surveying comprising:
(a) locating a hydrant monument;
(b) mounting a survey instrument to a support plate, said support plate having an upper surface and a lower surface; and
(c) mounting said support plate with said survey instrument attached thereto to said hydrant monument.

45. A method as claimed in claim 44 further comprising using an attachment device to secure said survey instrument at said upper surface of said support plate.

46. A method of surveying comprising:
(a) locating a hydrant monument; and
(b) mounting a survey instrument having an upper plate connected to said lower plate so that said upper plate can be leveled relative to said lower plate, to said hydrant monument.
